(19) United States
(12) Patent Application Publication
(10) Pub. No.: US 2013/0060969 A1
(43) Pub. Date: Mar. 7, 2013

(54) AUTOMATED DEVICE INTEGRATION

(71) Applicants: Martti Tapani Ylikoski, Helsinki (FI); Ivan Bodunov, Espoo (FI); Martin Heisch, Berlin (DE); Sameer Babu Kunjumakal Kasim, Kerala (IN); Ricardo Marques, Azambuja (PT); Robert Pitchford, Basingstoke (GB)

(72) Inventors: Martti Tapani Ylikoski, Helsinki (FI); Ivan Bodunov, Espoo (FI); Martin Heisch, Berlin (DE); Sameer Babu Kunjumakal Kasim, Kerala (IN); Ricardo Marques, Azambuja (PT); Robert Pitchford, Basingstoke (GB)

(73) Assignee: NOKIA SIEMENS NETWORKS OY, Espoo (FI)

(21) Appl. No.: 13/695,722

(22) PCT Filed: Mar. 4, 2011
(86) PCT No.: PCT/EP2011/053330

§ 371 Date: Nov. 1, 2012

Related U.S. Application Data
(63) Continuation-in-part of application No. 12/776,838, filed on May 10, 2010, now abandoned.

(51) Int. Cl. G06F 3/00; G06G 7/62

(52) U.S. Cl. 710/10; 710/16; 703/21

(57) ABSTRACT

A method and system is provided in which new types of devices (such as sensors) can be integrated into a network in an automated manner. The system includes a repository for device information. When a new device is detected in a network, a management system for the network obtains device information from the repository and uses that information to integrate the device into the network.

The present invention relates to the automation of the setup of devices, such as sensors, in a network.

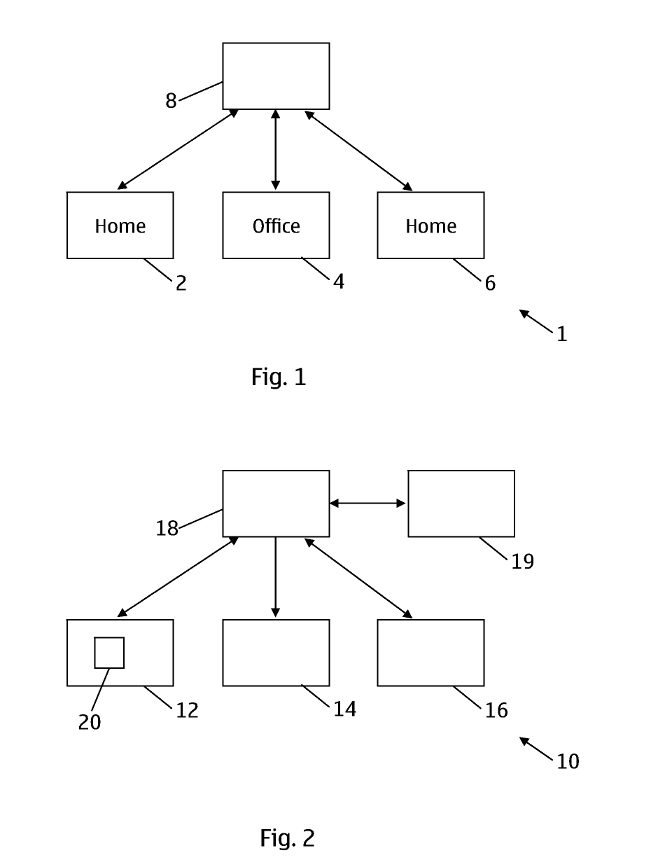

FIG. 1 is a block diagram, indicated generally by the reference numeral 1, showing a number of managed systems. The system 1 comprises a first system 2, a second system 4 and a third system 6. The first, second and third systems are each in two-way communication with a management system 8.

Each of the systems 2, 4 and 6 include a number of sensors or other devices. The sensors provide data to the management system 8 that takes action dependent on the output of the sensors.

By way of example, the management system 8 may be provided by a security company. The first system 2 may be the home of a first user, the second system 4 may be the office of the first user and the third system 6 may be the home of a second user. The systems 2, 4 and 6 may contain a range of sensors, such as movement sensors and door sensors, that provide data to the management system 8.

The management system 8 takes action in response to the data received from the sensors of the systems 2, 4 and 6. For example, in the event that a potential problem occurs in the system 2, the first user may be contacted by telephone to determine if there is a problem. If no reply is received, then the police may be called.

Different system may have different configurations. For example, the second system 4 (being an office) may be controlled in a different way to the first and third system (which are both homes). Similarly, the third system 6 may be controlled in a different manner to the first system 2, perhaps because the second user is paying a higher premium for a superior service.

The sensors included within the systems 2, 4 and 6 need to communicate with the management system 8. In order to do so, the management system needs to understand the data that is provided by the sensors of those systems. Similarly, the sensors need to understand any messages that are provided from the management system 8 to those systems. This is typically achieved by using sensors provided by the same company that provides the management system 8, so that the security company can ensure that the sensors are correctly configured. Such devices can readily be pre-configured by (or under the control of) that security company so that all parties can be confident that the devices and the management system 8 will be able to communicate effectively and accurately.

A problem with the system 1 is that it lacks flexibility. For example, the sensors included in the system 2, 4 and 6 may typically need to be obtained from the security company operating the management system 8. Such an arrangement may prevent a user of one of the systems 2, 4 and 6 from choosing their own sensors. For example, a specialist sensor provider may provide a superior and/or cheaper range of sensors than the company providing the system 8. A user may wish to use such sensors but be prevented from doing so.

Furthermore, the system 1 lacks flexibility in the sense that it is difficult for companies to provide new sensor types for inclusion in the system. Indeed, it may even be difficult in some circumstances to change the sensor configuration to include new sensors of a type that is known to the management system 8.

In a distributed system without a central control authority, devices (and device types) typically come and go. A management system operating in such an environment requires a level of flexibility that is not typically provide by the prior art.

The present invention seeks to address at least some of the problems outlined above.

The present invention provides an apparatus (such as a management system) comprising: a first interface adapted to communicate with one or more systems, wherein the system include one or more devices providing data to the apparatus; a second interface adapted to communicate with a repository of configuration information for devices, wherein when a new device of an unknown type (to the apparatus) is detected in one of said one or more systems, the apparatus obtains device information from the repository and uses that information to integrate the device into the network.

The present invention also provides a method (for example, for integrating new types of devices (such as sensors) into a network in an automated manner), the method comprising: communicating with one or more systems, wherein the or each system comprise one or more devices; receiving or obtaining an indication that a device is newly installed in one of said one or more systems; contacting a repository to obtain device information for the device, in the event that the newly installed device is of a previously unknown type; and using said device information to integrate the device into the network.

The first interface may be adapted to receive an initialisation message from devices when such devices are newly installed in the one of said one or more systems. In this way the apparatus becomes aware of the presence of a new device, which may or may not be known to the apparatus. If it is known, it can be readily incorporated into the system: if it is unknown, the apparatus must obtain data regarding the new device from the repository.

The invention may include polling each of said systems to request data regarding any newly installed devices.

The apparatus may further comprise a processor, where the processor may be adapted to use the first interface to poll one or more of said system to determine whether or not a new device has been installed in the said system.

In some forms of the invention, on identifying a new device, a unique identifier for the device (or the device type) is obtained for use in obtaining device information from said repository (if necessary). The said repository may provide device information in the form of a mediation language file.

The invention may include communicating with one or more of said systems over said first interface using a mobile telecommunications network. The invention may use identification mechanisms of said mobile telecommunications network to identify a user at one or more of said systems. The invention may use identification mechanisms of said mobile telecommunications network for billing purposes.

Thus, the invention may provide a method, apparatus and system in which new types of devices (such as sensors) can be integrated into a network in an automated manner. The system includes a repository for device information. When a new device (or a previously unknown type) is detected in a network, a management system for the network obtains device information from the repository and uses that information to integrate the device into the network.

The present invention also provides a device (such as a sensor or a metering device) comprising: a first output for sending an initialisation message to a predefined location when the device is used in an unconfigured state; and a first input for receiving configuration information for the device, wherein the configuration information is obtained from a repository that is populated with data by the manufacturer of the device.

The present invention further provides a method (for example, of uploading data to a repository) comprising: using a simulated management system to simulate the use of a device; using results of the simulation to generate a mediation language file describing a management module of the device; and uploading the mediation language file to a repository of device information.

The present invention also provides a computer program comprising: code (or some other means) for communicating with one or more systems, wherein the or each system comprise one or more devices; code (or some other means) for receiving or obtaining an indication that a device is newly installed in one of said one or more systems; code (or some other means) for contacting a repository to obtain device information for the device, in the event that the newly installed device is of a previously unknown type; and code (or some other means) for using said device information to integrate the device into the network. The computer program may be a computer program product comprising a computer-readable medium bearing computer program code embodied therein for use with a computer.

The present invention yet further provides a computer program comprising: code (or some other means) for using a simulated management system to simulate the use of a device; code (or some other means) for using results of the simulation to generate a mediation file describing a management module of the device; and code (or some other means) for uploading the mediation language file to a repository of device information. The computer program may be a computer program product comprising a computer-readable medium bearing computer program code embodied therein for use with a computer.

Exemplary embodiments of the invention are described below, by way of example only, with reference to the following numbered schematic drawings.

FIG. 1 is a block diagram of a system including a number of managed systems;

FIG. 2 is a block diagram of a system in accordance with an aspect of the present invention;

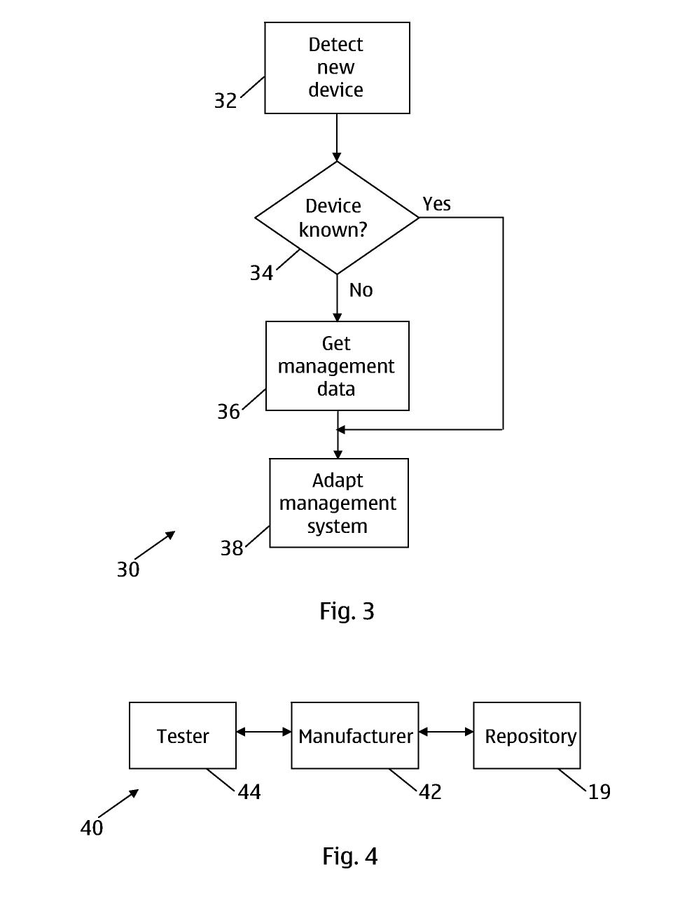

FIG. 3 is a flow chart showing an algorithm in accordance with an aspect of the present invention; and

FIG. 4 is a block diagram of a system in accordance with an aspect of the present invention.

FIG. 2 is a block diagram, indicated generally by the reference numeral 10, of a system in accordance with an aspect of the present invention. The block diagram 10 includes a first system 12, a second system 14 and a third system 16 that are similar to the systems 2, 4 and 6 described above. The first, second and third systems 12, 14 and 16 are each in two-way communication with a management system 18. The management system 18 is similar to the management system 8 described above.

Each of the systems 12, 14 and 16 include a number of sensors or other devices. The sensors provide data to the management system 18 that takes action dependent on the output of the devices. For example, as described above with reference to the system 1, the management system 18 may be provided by a security company and the systems 12, 14 and 16 may be homes and/or offices of users of the security company's services. Of course, many other configurations of the system 10 are possible.

The system 10 also includes a sensor data repository 19. The repository is in two-way communication with the management system 18. As described in detail below, the management system 18 is able to use the sensor data repository 19 to obtain configuration information for a new device that is included in any one of the systems 12, 14 and 16. In this way, a device can be provided in one of those systems, without needing to be pre-configured for use with the management system 18.

Assume that a user at the system 12 acquires a new device 20. The device may be a sensor or it may be some other device. The device 20 is unknown to the management system and so, initially, the management system is unable to make use of the device 20. For example, the device 20 may be a new type of smoke detector that the owner of the system 12 has purchased from a device manufacturer. As described below, the present invention enables the device 20 to be incorporated into the management system 18, such that it can be used as intended.

FIG. 3 is a flow chart showing an algorithm, indicated generally by the reference numeral 30, in accordance with an aspect of the present invention. The algorithm 30 starts when the device 20 is first installed within the system 12.

The algorithm 30 starts at step 32, where the management system 18 detects that a new device has been installed in the system 12. The step 32 may be implemented in a number of ways. For example, the device 20 may be configured so that, on installation, it sends an “initialise” message to a predefined address. The initialise message may be sent to the management system 18. The initialise message may be sent to the manufacturer of the device 20. The initialise message may be sent using a mobile telecommunication infrastructure available at the system 12 (for example, using a mobile communication device of the system 12). The mobile communication infrastructure may be used to identify the owner of the device 12. This may be useful, for example, for security purposes. This may also be useful for billing purposes.

Alternatively, or in addition, the management system may regularly poll the systems that it is responsible for (the systems 12, 14 and 16 in the example of FIG. 2) in order to determine whether any new (and possibly unknown) devices have been included in the system.

The information transferred from the device 20 to the system 18 in the step 32 includes a unique identifier for the device. At step 34 of the algorithm 30, the management system 18 uses that unique identifier to determine whether or not that device type is known to the management system 18. If the device type is known, then the algorithm 30 moves to step 38. If the device type is unknown, then the algorithm 30 moves to step 36.

At step 36, the management system sends the unique identifier to obtain configuration information for the device 20 from the repository. This data is returned to the management system 18 and the algorithm 30 moves to step 38.

At step 38, the management system is adapted so that it understands the outputs provided by the device 20. The device 20 is then fully integrated into the system 12 and can be used to communicate with the management system 18.

FIG. 4 is a block diagram of a system, indicated generally by the reference numeral 40, in accordance with an aspect of the present invention. The system 40 demonstrates an exemplary mechanism to enable a manufacturer of the device 20 (or any other device) to upload configuration information to the repository 19. The system 40 is provided by way of example only. Many other possible arrangements for providing configuration data to the repository 19 will be apparent to the skilled person.

The system 40 comprises a manufacturer 42, a testing mechanism 44 and the repository 19.

The testing mechanism 44 provides a simulated management system that enables the device manufacturer 42 to independently test their device and its adaptation to the management system 18. The result of the testing can be used to generate a device description using a standardised mediation language. The mediation language provides a formal way of describing the management module of the device 20 (e.g. normal functionality of the device and what events the device can produce in abnormal conditions etc.) This file is uploaded to the repository 19 for use in configuring the management system 18 (or similar management systems).

Of course, the manufacturer could generate the file for uploading to the repository without using the testing mechanism 44, particularly if the manufacturer concerned was familiar with the mediation language used to generate the file.

Accordingly, the present invention provides a system in which new types of devices can be created and integrated into the system in an automated manner, with no change being required to the management system.

The invention enables device manufacturers to create new types of devices (such as sensors or metering devices). To help them in this work, embodiments of the invention provide:
A simulated management system that enables the device manufacturer to test independently their device and its adaptation to the network management system
A standardized mediation language. The mediation language is a formal way of describing the management model of the device (what events it can produce in abnormal conditions, what control signals are required, the meaning of outputs of the device etc.)

The device manufacturer can create new devices in a distributed manner without prior agreement and discussions with the infrastructure or service providers (such as the operator of the management system 18). Accordingly, new devices can be sold to end users, without needing to seek approval from the relevant management systems.

When the device is ready for commercial launch, the device manufacturer simply publishes mediation data to a public sensor mediation repository, such as the repository 19.

The invention enables consumers to purchase any device that fits their requirements, without needing to consider whether the management system already knows about the device. The user only needs to know that the device configuration information will have been provided to the relevant repository.

When the consumer powers up the device, the infrastructure will automatically detect the new device. The device could be automatically detected by one of the following mechanisms:
The device may send an “init” message to a predefined address. The routing in the operator network is organized so that the init message goes to the management system. The device type (e.g. a unique identifier) may be included in the init message.
Alternatively, an automated element detector polls the network to see if new devices have attached.

When a new device is detected, the relevant network management system uses the device identifier as a key to the sensor mediation repository.

The mediation descriptions in the repository are used to automatically adapt the management system. The new device type is now managed without any changes to the management system.

Periodically the management system can scan its internal device inventory to see if some device types are no longer used (no more devices attached of this type). When this happens, a grace period may be started. If no devices of the given type are detected during the grace period, all mediations may be removed from the database.

The present invention therefore enables new devices to be introduced in a totally distributed manner.

The present invention provides a system that requires only a simple protocol between devices and management systems and a simple protocol between management systems and repositories.

The embodiments of the invention described above are illustrative rather than restrictive. It will be apparent to those skilled in the art that the above devices and methods may incorporate a number of modifications without departing from the general scope of the invention. It is intended to include all such modifications within the scope of the invention insofar as they fall within the scope of the appended claims.

1. An apparatus comprising:
a first interface adapted to communicate with one or more systems, wherein the system include one or more devices providing data to the apparatus;
a second interface adapted to communicate with a repository of configuration information for devices,
wherein when a new device of an unknown type is detected in one of said one or more systems, the apparatus obtains device information from the repository and uses that information to integrate the device into the network.

2. An apparatus as claimed in claim 1, wherein the first interface is adapted to receive an initialisation message from devices when such devices are newly installed in the one of said one or more systems.

3. An apparatus as claimed in claim 1, further comprising a processor, where the processor is adapted to use the first interface to poll one or more of said system to determine whether or not a new device has been installed in the said system.

4. An apparatus as claimed in claim 1, wherein, on identifying a new device, the apparatus obtain a unique identifier for the device for use in obtaining device information from said repository.

5. An apparatus as claimed in claim 1, wherein the apparatus communicates with one or more of said systems over said first interface using a mobile telecommunications network.

6. An apparatus as claimed in claim 5, wherein the apparatus uses identification mechanisms of said mobile telecommunications network to identify a user at one or more of said systems.

7. A device comprising:
a first output for sending an initialisation message to a predefined location when the device is used in an unconfigured state; and
a first input for receiving configuration information for the device, wherein the configuration information is obtained from a repository that is populated with data by the manufacturer of the device.

8. A method comprising:
communicating with one or more systems, wherein the or each system comprise one or more devices;
receiving or obtaining an indication that a device is newly installed in one of said one or more systems;
contacting a repository to obtain device information for the device, in the event that the newly installed device is of a previously unknown type; and
using said device information to integrate the device into the network.

9. A method as claimed in claim 8, wherein integrating the device into the network includes configuring the device.

10. A method as claimed in claim 8 or claim 9, wherein said receiving or obtaining step includes polling each of said systems to request data regarding any newly installed devices.

11. A method comprising:
using a simulated management system to simulate the use of a device;
using results of the simulation to generate a mediation language file describing a management module of the device; and
uploading the mediation language file to a repository of device information.

12. A computer program product comprising:
means for communicating with one or more systems, wherein the or each system comprise one or more devices;
means for receiving or obtaining an indication that a device is newly installed in one of said one or more systems;
means for contacting a repository to obtain device information for the device, in the event that the newly installed device is of a previously unknown type; and
means for using said device information to integrate the device into the network.

13. A computer program product comprising:
means for using a simulated management system to simulate the use of a device;
means for using results of the simulation to generate a mediation file describing a management module of the device; and
means for uploading the mediation language file to a repository of device information.
